(19) United States
(12) Patent Application Publication
(10) Pub. No.: US 2004/0124366 A1
(43) Pub. Date: Jul. 1, 2004

(54) Apparatus and methods relating to high speed spectroscopy and excitation-emission matrices

(76) Inventors: Haishan Zeng, Vancouver (CA); Harvey Lui, Vancouver (CA); Zhiwei Huang, Vancouver (CA)

Correspondence Address: GRAYBEAL, JACKSON, HALEY LLP, 155 - 108TH AVENUE NE, SUITE 350, BELLEVUE, WA, 98004-5901, US

(21) Appl. No.: 10/677,632

(22) Filed: Oct. 2, 2003

Related U.S. Application Data
(60) Provisional application No. 60/415,827, filed on Oct. 2, 2002.

(51) Int. Cl. G01N 21/64

(52) U.S. Cl. 250/458.1

(57) ABSTRACT

Spectral measurement devices and methods able to provide EEMs and other spectral measurements. The devices rapidly and specifically illuminate a sample and detect resulting light emanating from the sample. Such devices can use acousto-optic tunable filters (AOTFs) to selectively illuminate the sample with illumination light substantially only in a desired illumination wavelength(s). This provides high detection sensitivity, large measurement dynamic range and scans of the full 400-1000 nm light range (or more) at rates as fast as about 1 second, or even as fast as video rates. In another aspect, methods and systems relating to the analysis of autofluorescence emanating from melanin under long wavelength visible light (VIS) and near infrared (NIR) excitation.

### CROSS-REFERENCE TO RELATED APPLICATIONS

The present application claims priority from U.S. provisional patent application No. 60/415,827, filed Oct. 2, 2002.

### BACKGROUND

Autofluorescence refers to the intrinsic ability of tissues to re-emit absorbed light photons at wavelengths different from those that were initially absorbed. Autofluorescence has been studied over the last decade for non- or minimally-invasive medical diagnosis. Autofluorescence is determined by tissue morphology and biochemical composition and can therefore be used for characterizing tissues in health and disease. Wagnieres, et al., “In vivo fluorescence spectroscopy and imaging for oncological applications,” Photochem Photobiol 68(5): 603-32, 1998. Specific native tissue fluorophores that give rise to autofluorescence include tyrosine, tryptophan, collagen, elastin, flavins, porphyrins, and nicotinamide adenine dinucleotide (NAD). Gillies, et al., Fluorescence excitation spectroscopy provides information about human skin in vivo, J Invest Dermatol, 115(suppl4): 704-707, 2000. Fluorescence emission is also dependent on the wavelength of illumination or excitation light used to excite the fluorescence, and this interaction can be studied systematically by measuring fluorescence emission spectra at multiple excitation wavelengths. Zeng, et al., Spectroscopic and microscopic characteristics of human skin autofluorescence emission, Photochem Photobiol 61: 639-645, 1995.

Data thus obtained can be depicted, for example, by either 3-D spectral graphs (FIG. 1A; Zeng, et al., supra), or more simply through a 2-D spectral contour plot, known as an excitation-emission matrix (EEM) (FIG. 1B; Zeng, et al., supra). In the literature, most work to date on tissue fluorescence spectroscopy has been performed under excitation wavelengths ranging between ultraviolet (UV) and shorter wavelength visible light (VIS). See, e.g., R. R. Alfano, et al., Fluorescence spectra from cancerous and normal human breast and lung tissue, IEEE J. of Quantum Electronics 23: 1806-1811 (1987); Richards-Kortum R, et al., Spectroscopic diagnosis of colonic Dysplasia, Photochem Photobiol, 53(6): 777-86, 1991; A. Mahadevan, et al., Study of the fluorescence properties of normal and neoplastic human cervical tissue, Lasers Surg. Med. 13: 647-655 (1993); R. A. Zângaro, et al., “Rapid Multi-Excitation Fluorescence Spectroscopy System for In vivo Tissue Diagnosis,” Applied Optics 35: 5211-5219 (1996); Ingrams, et al., Autofluorescence characteristics of oral mucosa, Head & Neck, 19: 27-32 (1997); Zuluaga, et al., Fluorescence excitation emission matrices of human tissue: a system for in vivo measurement and data analysis, Appl Spectrosc, 53: 302-311, 1999; Zeng, et al., System for fast measurement of in vivo fluorescence spectra of the gastrointestinal tract at multiple excitation wavelengths, Appl. Optics 38(34):7157-7158, 1999; Heintzelman, et al., Optimal excitation wavelengths for in vivo detection of oral neoplasia using fluorescence spectroscopy, Photochem Photobiol 72(1): 103-13, 2000; MacAulay, et al., Variation of fluorescence spectroscopy during the menstrual cycle, Optics Express, 10: 493-504, 2002.

Longer red to near infrared (NIR) wavelength fluorescence measurements have been performed at few excitation wavelengths and mostly for examining tissue porphyrins-related fluorescence. See, e.g., Zhang, et al., Far-red and NIR spectral wing emission from tissue under 532-nm and 632-nm photo-excitation, Lasers in Life Sciences, 9: 1-16, 1999; Hanlon, et al., Near-infrared fluorescence spectroscopy detects Alzheimer's disease in vitro, Photochem Photobiol 70(2): 236-242, 1999; Demos, et al., Tissue imaging for cancer detection using NIR autofluorescence, SPIE Proc., 4613: 31-34, 2002.

One advantage of longer red to NIR spectroscopy over UV and shorter wavelength VIS is the deeper effective tissue penetration that can be achieved at longer wavelengths, thereby facilitating deeper optical interrogation of tissue.

One way to investigate fluorescence and other light data is the use of a spectroscopy system such as an EEM system. Such devices comprise at least two elements, a tunable excitation (or other illumination) light source module and an emission detection module. In typical existing EEM systems, four different types of tunable excitation light source modules are typically used: (1) an arc lamp coupled with a monochromator plus interference bandpass filters, (2) an arc lamp coupled with double monochromators, (3) a nitrogen-pumped dye laser, and/or (4) an OPO (optical parametric oscillator) tunable laser. All four of these types of tunable light sources use stepper motor type mechanisms for rotating gratings or filter wheels, or crystals for wavelength-tuning excitation light wavelengths. Gillies, supra; Richards-Kortum, supra; Mahadevan, supra; Zângaro, supra; Ingrams, supra; Zuluaga, supra; Zeng, supra; Heintzelman, supra; MacAulay, supra. This mechanical movement imposes limitations on the speed of tuning from one wavelength to another, and therefore also on the overall measurement efficiency.

There are typically two different types of emission detection module. Id. One is a wavelength scanning, single-channel detector system, in which wavelength scanning is usually implemented by a monochromator or double monochromator coupled with a stepper motor to rotate the gratings, and the detector is usually a photomultiplier tube (PMT). The other is an imaging spectrograph, multi-channel detector system, in which the multi-channel detector is usually a CCD array detector. The single channel, monochromator-PMT system has high sensitivity and wide dynamic range, but slow spectral acquisition due to the stepper motor, which mechanically scans through the measurement wavelengths. On the other hand, the multichannel, imaging spectrograph-CCD system is capable of faster spectral measurement, but at a lower sensitivity and dynamic range, particularly when measurements are performed rapidly. This limitation can be reduced by increasing the exposure time, but that slows the measurement. For EEM measurements, a filter wheel comprising a plurality of optical filters is typically placed in front of the imaging spectrograph to process light.

Thus, there has gone unmet a need for improved systems and methods and the like to provide high quality spectroscopy with close and rapid control of illumination and detection. The present systems and methods, etc., provide these and other advantages.

### SUMMARY

The present invention comprises spectral measurement devices able to provide EEMs and other spectral measurements. The devices rapidly and specifically illuminate a sample and detect resulting light emanating from the sample. Such devices can use acousto-optic tunable filters (AOTFs) to selectively illuminate the sample with illumination light substantially only in a desired illumination wavelength(s). AOTFs can also be used with a suitable detector. This provides high detection sensitivity, large measurement dynamic range and scans of the full 400-1000 nm light range at rates as fast as about 10 seconds to less than about 1 second, or even as fast as video rates such about 30 ms to about 15 ms. In another aspect, the present invention provides methods and systems relating to the analysis of autofluorescence emanating from melanin under long wavelength visible light (VIS) and near infrared (NIR) excitation. For example, under 785 nm excitation light, melanin significant fluorescence emission with a peak at about peak about 880 nm-900 nm. Rapid spectroscopy and/or analysis of fluorescence from long wavelength VIS and NIR excitation can also be used to evaluate topical pharmaceuticals, assay and quantify drug delivery in photodynamic therapy, validate the UV light protection of sunscreens, and determine epidermal proliferation. Rapid spectroscopy can even be used to improve the performance of HPLC instrumentation (Hart, et al., A laser-induced fluorescence dual-fiber optic array detector applied to the rapid HPLC separation of polycyclic aromatic hydrocarbons, Anal Bioanal Chem, 372(1): 205-215, 2002) as well as for medical, scientific, industrial and other applications.

In one aspect, the present invention can comprise high speed spectral measurement systems comprising at least one light source, an illumination acousto-optic tunable filter (AOTF) configured to receive light from the light source and to selectively transmit substantially only illumination light in a desired illumination wavelength range to a sample, and a detector disposed to detect emission light emanating from the sample, wherein at least the illumination AOTF and the detector can be operably connected to a computer that controls the illumination AOTF and the detector and integrates data regarding the illumination AOTF and the detector.

The system can further comprise a detection AOTF configured to receive emission light from the sample and to selectively transmit to the detector substantially only light in a desired detection wavelength range. The desired detection wavelength range can comprise emission light from fluorophores excited by the fluorescence excitation light and the detector can be a photomultiplier detector. The computer can be configured to vary the desired illumination wavelength range of the illumination AOTF to provide a desired fluorescence excitation light and can be configured to vary the desired detection wavelength range of the detection AOTF to detect fluorescent light from fluorophores excited by the desired fluorescence excitation light.

The system can further comprise a second illumination AOTF downstream from the first illumination AOTF and operably connected to the computer to work in series with the first illumination AOTF to provide almost complete out of band rejection of undesired light, and the system can further comprise a second detection AOTF downstream from the first detection AOTF and operably connected to the computer to work in series with the first detection AOTF to provide almost complete out of band rejection of undesired light. The out of band rejection can be better than at least about 10-6.

The system can comprise an illumination light guide configured to transmit the illumination light from the illumination AOTF to the sample and a detection light guide disposed to transmit the detection light from the sample to the detection AOTF. The light guides can be flexible light guide bundles each comprising a plurality of optical fibers and the illumination light guide and the detection light guide can form a bifurcated light guide wherein the illumination light guide provides an illumination branch and the detection light guide provides a pick-up branch that combine to form a common end. The light guide can be configured to non-invasively interrogate skin.

The system can be configured such that the desired illumination wavelength range can be less than about 5 nm, the desired illumination wavelength range can be less than about 1 nm FWHM, the system can selectively excite and selectively detect long wavelength VIS-induced and NIR-induced fluorescence, and the system can be configured to access discrete wavelengths at rates of at least about 10 KHz, for example from at least about 400 nm to 1000 nm.

In another aspect, the present invention provides high speed excitation-emission matrix (EEM) spectroscopy systems comprising at least one light source, an illumination AOTF and a detection AOTF, and a detector wherein at least the illumination AOTF, the detection AOTF and the detector can be operably connected to a computer that controls the illumination AOTF, the detection AOTF and the detector and integrates data regarding the illumination AOTF, the detection AOTF and the detector to provide an EEM of the sample. The EEM can be a 2-dimensional, 3-dimensional EEM or other dimensional EEM as desired. The system can be configured to operate at rates sufficient to obtain substantially complete data for an EEM from about 400 nm to 1000 nm at excitation wavelength steps separated by about 10 nm in less than about 3 seconds, 0.9 seconds, or 15 ms.

The systems can comprise second illumination and detection AOTFs, the out of band rejection can be better than at least about 10-6, and the systems can comprise light guides, as such as discussed elsewhere herein (unless expressly stated otherwise or clear from the context, all embodiments, aspects, features, etc., can be mixed and matched, combined and permuted in any desired manner). The systems can selectively excite and selectively detect long wavelength VIS-induced fluorescence and NIR-induced fluorescence.

In a further aspect, the present invention comprises methods of detecting autofluorescence in a sample comprising: Illuminating the sample with at least one of a long wavelength VIS and NIR excitation light filtered through at least one acousto-optic tunable filter (AOTF), and detecting via a detector fluorescence emission light emanating from the sample. The methods can be computer implemented, can comprise filtering the fluorescence emanation light through a detection AOTF upstream from the detector, amplifying the light, and can further comprise analyzing the emission light and determining therefrom at least one characteristic about melanin in the sample.

The computer can be configured to vary the desired illumination wavelength range of the illumination AOTF to provide a desired fluorescence excitation light and vary the desired detection wavelength range of the detection AOTF to detect fluorescent light from fluorophores excited by the desired fluorescence excitation light. The methods can further comprise filtering the emission light through a second detection AOTF downstream from the first detection AOTF and filtering the illumination light through a second illumination AOTF downstream from the first illumination AOTF, to provide almost complete out of band rejection of undesired light. The methods can also comprise transmitting the illumination light through an illumination light guide and transmitting the fluorescence emission light through a detection light guide. The light guides can be configured to form a bifurcated light guide wherein the illumination light guide provides an illumination branch and the detection light guide provides a pick-up branch that combine to form a common end. The methods can also comprise non-invasively interrogating skin. The methods can comprise creating an EEM depicting the fluorescence emission light emanating from the sample, which EEM can be 2-dimensional, 3-dimensional or other dimensional as desired.

In still another aspect, the present invention comprises methods of analyzing melanin in a sample. The methods comprising a) illuminating the sample with excitation light comprising at least one of long wavelength visible (VIS) and near infrared (NIR) light, b) inducing autofluorescence from the melanin due to the excitation light, and c) measuring the autofluorescence and therefrom analyzing at least one characteristic of the melanin. The excitation light can consist essentially of long wavelength visible (VIS) and near infrared (NIR) light such as 785 nm light, and the autofluorescence can be induced and measured in less than about 30 ms or otherwise as discussed herein.

The autofluorescence can comprise a peak at about 880 nm-900 nm and the analyzing can comprise using the peak to identify the melanin, and the methods can quantify the amount of melanin. The autofluorescence can be induced and measured using a system as discussed herein.

The methods herein can also comprise rapidly detecting autofluorescence in a sample. The methods can comprise scanning the sample with an about 5 nm wavelength band of excitation light, the scanning covering a wavelength range of at least about 200 nm of wavelengths of light and proceeding at a rate fast enough to covering at least about 600 nm of wavelengths in less than about 10 seconds, and detecting through a filter configured to substantially block the excitation light fluorescence emission light emanating from the sample.

Methods herein also include analyzing possible cancer in a sample comprising a) illuminating the sample with excitation light comprising at least one of long wavelength visible (VIS) and near infrared (NIR) light, b) inducing autofluorescence from cancerous portions in the sample, if any, due to the excitation light, and c) measuring the autofluorescence and therefrom analyzing at least one characteristic of the possible cancer. The excitation light can consist essentially of long wavelength visible (VIS) and near infrared (NIR) light, for example about 785 nm light, can be induced and measured in less than about 30 ms, and can be performed using a system as discussed herein.

In some embodiments, the scanning covers at least about 600 nm of wavelengths and proceeds at a rate fast enough to scan the about 600 nm of wavelengths in less than about 1 second, 30 ms or 15 ms. The scanning can a wavelength range consisting essentially from about 200 nm to about 1100 nm, or can cover a wavelength range comprising UV wavelengths, long wavelength visible (VIS) and near infrared (NIR) light, or otherwise as desired.

These and other aspects, features and embodiments are set forth within this application, including the following Detailed Description and attached drawings. Unless expressly stated otherwise or clear from the context, all embodiments, aspects, features, etc., can be mixed and matched, combined and permuted in any desired manner. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1A depicts a 3-D representation of in vivo skin fluorescence emission spectral data at different excitation wavelengths.

FIG. 1B depicts a 2-D EEM of in vivo skin autofluorescence emission. This represents a 2-D contour plot of the spectral data of FIG. 1A.

FIG. 2 depicts a block diagram of a VIS/NIR fluorescence EEM spectroscopy system.

FIG. 3 depicts a schematic representation of a TeO2 AOTF.

FIG. 4 depicts fluorescence from three different melanin samples under 785 nm NIR light excitation.

FIG. 5 depicts fluorescence from black and white human hairs under 785 nm NIR light excitation.

FIG. 6A depicts fluorescence spectra of a vitiligo lesion and its surrounding normal skin measured under 437 nm excitation light.

FIG. 6B depicts a fluorescence spectra of the same lesion as in FIG. 6A under 785 nm NIR light excitation.

FIG. 7A depicts a fluorescence from a compound nevus and its surrounding normal skin under 785 nm NIR light excitation.

FIG. 7B depicts a fluorescence spectra of a compound nevus and its surrounding normal skin measured under 437 nm light excitation.

FIG. 8 depicts a fluorescence from a mouse tumor and its surrounding normal skin under 785 nm NIR light excitation.

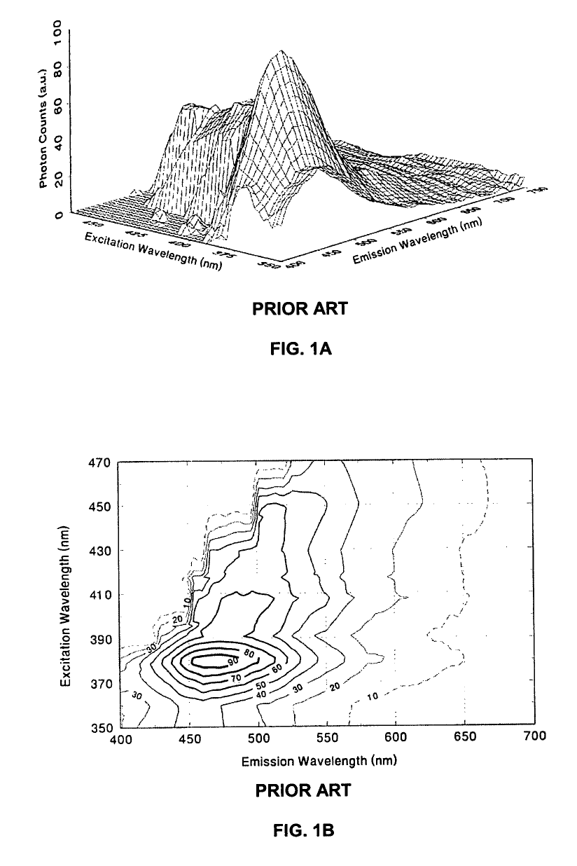

### DETAILED DESCRIPTION

The present systems and methods provide spectroscopes, spectrographs and other spectral measurement devices able to rapidly and specifically illuminate a sample and detect resulting light emanating from the sample. The resulting data can be reported in a 2-D or 3-D EEM, or in another representation such as a plot, line graph, spectral graph or otherwise as desired. Such devices use acousto-optic tunable filters (AOTF) configured to receive light from a light source such as a short arc Xenon lamp and to selectively transmit substantially only illumination light in a desired illumination wavelength range to a sample. Advantageously, the wavelength tuning can be purely electronic without any moving mechanical parts unless desired, with a reduction in the entire 400-1000 nm scanning time to as short as 50 ms to 20 ms or 15 ms or less. AOTFs are also used in combination with a suitable detector such as a PMT detector in the emission detection module. This provides high detection sensitivity, large measurement dynamic range and rapid wavelength scanning, the scanning of the entire wavelength range from 400 to 1000 nm can be completed in as short as about 50 ms to 20 ms or 15 ms or less. The ability to rapidly acquire data to provide EEMs or other desired representations and other spectral information is a significant feature for using a biomedical device in clinical settings, for example because speedy systems reduce patient discomfort by reducing the time to perform various procedures.

In another aspect, the present invention provides methods and systems relating to the detection, analysis, etc., of autofluorescence emanating from melanin under long visible light (VIS) and near infrared (NIR) excitation, including determining characteristics such as presence, identity, quantity, variations in concentration amongst different locations in a sample, etc., of the melanin therefrom. For example, under 785 nm excitation light, melanin exhibits significant fluorescence emission with a peak at about 880 nm-900 nm. This is in sharp contrast to melanin's very weak fluorescence at UV or short wavelength VIS light. Kozikowski, et al., IEEE J. Quantum Electronics, QE-20(12): 1379-1382, 1984; Gallas, et al., Fluorescence of melanin-dependence upon excitation wavelength and concentration, Photochem Photobiol 45(5): 595-600,1987.

Definitions.

Before turning to a more complete discussion of various aspects and embodiments, it may be advantageous to review some definitions. Accordingly, the following paragraphs provide definitions of some of the terms used herein. All terms used herein, including those specifically discussed below in this section, are used in accordance with their ordinary meanings unless the context or definition clearly indicates otherwise. Also unless indicated otherwise, except within the claims, the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

An “AOTF” or acousto-optic tunable filter is a well known device that provides highly filtered, specific light of a variable, selectable wavelength. As used herein, AOTF includes the various elements of an AOTF, including for example a crystal, an acoustic transducer, an acoustic absorber, a beam stop, etc.

A “computer” is a device that among other things is capable of controlling an AOTF, light source, detector or other elements of the systems and methods discussed herein. For example, the computer can control the light communication characteristics of an AOTF, or light detector (such as a photomultiplier tube (PMT), which can be a single channel detector, charge coupled device (CCD), avalanche photodiode (APD) or charge injection device (CID)), and/or integrate data generation and collection, compile data from the AOTF(s) and the detector(s), including using such data to make or reconstruct spectra of a sample, including fluorescence and reflective spectra, or as feedback to control an AOTF or other device. A computer comprises a central processing unit (CPU) or other logic-implementation device, and can be, for example, a stand alone computer such as a desk top or laptop computer, a computer with peripherals, a plurality of computers connected by a local or internet network, etc. Computers are well known and selection of a desirable computer for a particular aspect or feature is within the scope of a skilled person in view of the present disclosure.

A “light guide” is a well known device, typically flexible, that comprises an outer layer and a light transmissive core that carries light from one location to another, such as an optical fiber, liquid light guide or hollow reflective light guide. The outer layer can comprise the outer surface of the same material that makes up the core or can be a separate or additional material. A light guide typically also comprises a substantially non-light transmissive cladding. A “light guide bundle” is a plurality of such light guides combined into a single strand, and can comprise a binder or filler material between the individual light guides of the bundle.

The scope of the present systems and methods, etc., includes both means plus function and step plus function concepts. However, the terms set forth in this application are not to be interpreted in the claims as indicating a “means plus function” relationship unless the word “means” is specifically recited in a claim, and are to be interpreted in the claims as indicating a “means plus function” relationship where the word “means” is specifically recited in a claim. Similarly, the terms set forth in this application are not to be interpreted in method or process claims as indicating a “step plus function” relationship unless the word “step” is specifically recited in the claims, and are to be interpreted in the claims as indicating a “step plus function” relationship where the word “step” is specifically recited in a claim.

Other terms and phrases in this application are defined in accordance with the above definitions, and in other portions of this application.

Spectral Measurement System

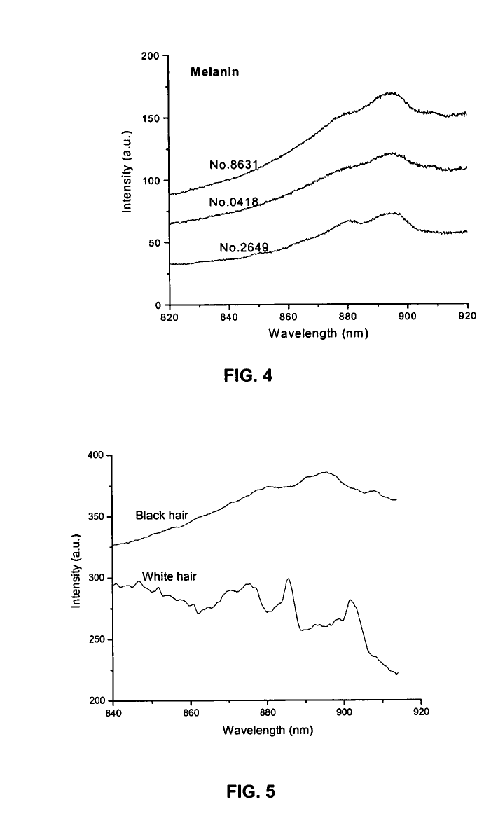

As discussed further below, data showing significant autofluorescence excited by long wavelength VIS and UV light (FIGS. 4-8) are one demonstration of the need for a spectral measurement system that can provide more complete characterization of tissue fluorescence beyond UV-VIS, for example by efficiently capturing EEMs for such long wavelength VIS and NIR fluorescence. A high speed spectral measurement system 2 suitable for use as an EEM device for these long wavelength bands facilitates research and leads to more effective exploitation of tissue autofluorescence.

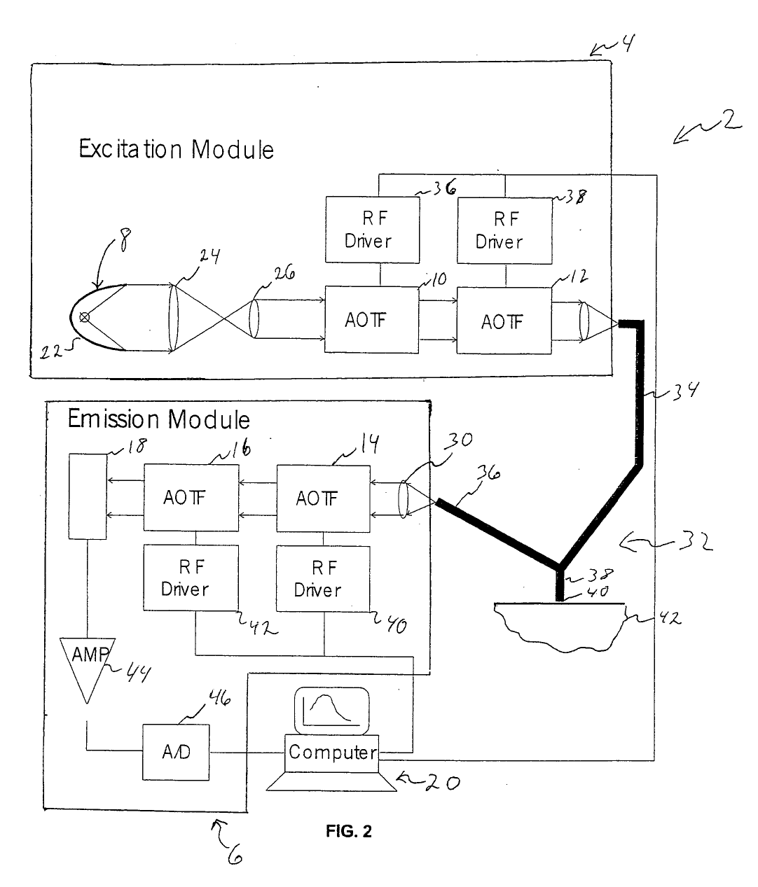

In one embodiment, as shown in FIG. 2, the system 2 can comprise an illumination module 4 (which in the embodiment shown is an excitation module) comprising a Xenon arc lamp as a light source 8, an emission module 6 comprising a detector 18 such as a photomultiplier detector, and up to four, or more, AOTFs 10-16, disposed in the two modules, and an operably connected computer 20. As depicted, the two modules are physically separate; the modules can also be combined if desired. Such systems can be used to investigate and analyze VIS to NIR fluorescence, tissue melanin autofluorescence properties, and other cutaneous fluorophores excited by light in the red/NIR wavelength ranges, as well as other medical and non-medical purposes.

In the embodiment depicted in FIG. 2, the illumination module 4 is disposed upstream from the sample and comprises a Xenon arc lamp (e.g., Model P150AFM, Perkin Elmer) as light source 8 (other suitable light sources include metal halide lamps, light sources with a boosting source at a particular wavelength or wavelength band, tungsten lamps, or otherwise as desired) and two illumination AOTFs 10, 12 (e.g., Model TEAF10-0.40-1.0-2ch-S, Melles Griot Canada). In some embodiments, the illumination light is a desired fluorescence excitation light. The Xenon arc lamp comprises a parabolic reflector 22 and outputs a 25 mm diameter collimated beam. First and second lenses 24, 26 contract the beam to a 10 mm diameter parallel beam for import to first illumination AOTF 10 which comprises a 10×10 mm aperture. Second illumination AOTF 12 is mounted after first illumination AOTF 10 to achieve an almost complete out of band rejection, for example better than 10-6. Filtered light output is focused by third lens 28 to the illumination branch 34 of a bifurcated light guide 32, which in the embodiment shown is a fiber bundle. This illumination module 4 provides tunable light from about 400 nm to about 1000 nm with a bandwidth of 5-10 nm or more or less as desired; higher and lower wavelength ranges are also suitable, for example from about 200 nm to about 1100 nm. Other desired illumination wavelength ranges and greater or smaller bandwidths can be used if desired. The excitation wavelengths can be switched rapidly under the computer control, with first and second SPS type RF drivers 48, 50, resulting in complete scanning from about 400 to 1000 nm within about 15 ms.

The emission detection module 6 is disposed in the light path downstream from the sample and comprises third and fourth detection AOTFs 14, 16 and a PMT detector 18 as well as associated electronics. The third and fourth detection AOTFs 14, 16 are used in series to achieve an out of band rejection of better than 10-6 so that backscattered excitation light will not significantly affect the fluorescence measurements. Fourth lens 30 collimates the fluorescence emission light and backscattered excitation light collected by the pick-up branch 36 of the bifurcated fiber bundle 32 for input to third detection AOTF 14. Third and fourth detection AOTFs 14, 16 are configured to pass light with a bandwidth of about 2 to 4 nm for better emission spectral resolution. Again the wavelength scanning is rapid and could be completed from 400 nm to 1000 nm (or other desired detection wavelength range) in 15 ms with third and fourth SPS type RF drivers 52, 54. The PMT (e.g., Hamamatsu R406, Spectra Research Corporation) detector 18 comprises a response wavelength range from at least about 400 nm to 1100 nm and can be connected to an amplifier 44 and a fast 16 bit A/D converter 46 for digitization of the spectral data to the PC computer 20. The computer 20 controls at least the RF drivers 48-54 of the 4 AOTFs 10-16 and the detector 18. Software, i.e., computer-implemented programming, provides one or more of system control, data acquisition, calibration, spectral display, spectral analysis, and other desired functions. The computer 20 can integrate data regarding (data from, data about, etc.) the excitation and the emission units into a computer-controlled fluorescence EEM spectroscopy system and/or perform other duties as desired. Of course, other or additional suitable data reception, measurement, processing and/or analyzing equipment can be used if desired.

A bifurcated fiber bundle 32 connects the illumination module 4 and the emission detection module 6. The bifurcated fiber bundle 32 comprises an illumination branch 34 and a pick-up branch 36 to interface with the illumination module 4 and the emission detection module, respectively. The illumination branch 34 and a pick-up branch 36 comprise an illumination light guide and a detection light guide, respectively. At the common end 38 the individual fibers from the illumination branch 34 and the pick-up branch 36 are mixed together randomly; other geometries and arrangements can also be used. In one embodiment suitable for skin detection, the distal tip 40 is flat cut and polished. Other configurations can be advantageously implemented for other uses such as internal scanning, non-medical uses, etc. When used with skin, the distal tip 40 can be applied to the skin with gentle contact during measurements.

For complete 3-D EEM fluorescence spectroscopy measurement in the 400 to 1000 nm wavelength range, the wavelength scanning time can be as short as (15 ms)×60=900 ms=0.9 seconds, assuming the excitation wavelengths are varied at 10 nm steps. Therefore, with a sufficiently sensitive PMT or other detection system, a complete 3-D EEM could be acquired in a few seconds, which is advantageous for in vivo tissue measurements.

Wavelength calibration can be done at manufacturing or otherwise as desired. Once data are inputted into the system software no further calibrations are typically needed unless desired. The spectral response of the emission detection module along with the pick-up fiber bundle can be calibrated using a NIST certified standard lamp (RS-10, EG & G Gamma Scientific) or otherwise as desired. The wavelength dependence of the excitation power at the fiber tip can be calibrated by measuring the power output of the fiber bundle common end 40 at pre-set excitation wavelengths using an optical power meter or otherwise as desired.

Reflectance spectra can also be measured by this system through programming the illumination module 4 and the emission detection module 6 to scan in tandem from 400 nm to 1000 nm. Reflectance spectra measured in this tandem scanning mode reduce or eliminate any interference from the fluorescence emission of the sample or tissue because both illumination and detection are restricted at the same narrow wavelength band. This is an important advantage for measuring high quantum efficiency fluorescence samples.

In certain embodiments, long pass (LP) filters and/or short pass (SP) filters are not utilized in the system, which leads to another advantage of the system since single photon-excited as well as two photon- or multi-photon excited fluorescence can be detected simultaneously. For two photon fluorescence excitation, as well as certain other uses, a pulsed light source or otherwise configured light source, may be desirable. For a conventional fluorescence spectroscopy system, a LP filter is needed for single photon excitation measurement, while a SP (short pass) filter is necessary for two photon or multi-photon fluorescence measurements. In the present system, emission spectra can also be obtained at extended wavelength ranges that are closer to the excitation wavelength than conventional systems with LP filters.

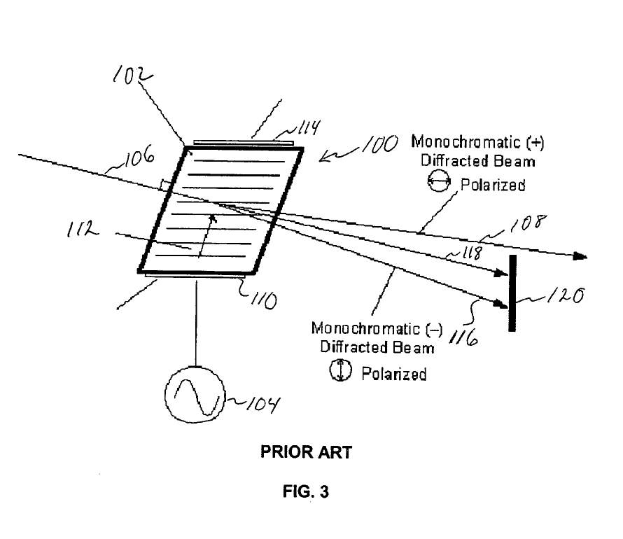

As discussed above, one of the elements of the systems herein is an AOTF. FIG. 3 depicts a schematic representation of a representative TeO2 AOTF 100. AOTF 100 acts as an electronically tunable spectral band pass (BP) filter. (See Gat, Imaging Spectroscopy Using Tunable Filters: A Review, Proc. SPIE 4056:50-64, 2000.) An AOTF is a solid state electro-optical device that does not need moving parts. It comprises a crystal in which acoustic (vibrational) waves from a RF driver 104 are used at radio frequencies (RF) to separate a single wavelength of light 108 from a broadband or multi-color light source 106. The most common types of AOTFs that operate in the VIS and NIR region use a crystal of tellurium dioxide (TeO2) 102 in a so-called non-collinear configuration—the acoustic and optical waves propagate at quite different angles through the crystal. Other elements can also be used, such as quartz collinear AOTFs or other AOTFs.

An acoustic transducer 110 is bonded to one side of the TeO2 crystal 102. This transducer 110 emits acoustic waves 112 (vibrations) when RF is applied to it. The acoustic waves 112 travel through TeO2 crystal 102 to acoustic absorber 114. The frequency of the vibrations equals the frequency of the applied RF. As these acoustic waves 112 pass through the TeO2 crystal 102, they cause the crystal lattice to be alternately compressed and relaxed. The resultant refractive index variations act like a transmission diffraction grating or Bragg diffracter. Unlike a classical diffraction grating, however, the AOTF 100 only diffracts one specific wavelength of light, so that it acts more like a filter than a diffraction grating. This is because the diffraction takes place over an extended volume, not just at a surface or plane, and that the diffraction pattern is moving in real time. The wavelength (λ) of light that is diffracted is determined by the “phase matching” condition as shown by:

λ=ΔnαVa/fa

where Δn is the birefringence of the TeO2 crystal 102, Va and fa are the velocity and frequency of the acoustic wave 112, and α is a complex parameter depending on the design of the AOTF. Wagnieres, et al., supra, Photochem Photobiol 68(5): 603-32,1998.

The wavelength of the light that is selected by this diffraction can therefore be varied simply by changing the frequency of the applied RF. As indicated in the figure, the diffracted light intensity is directed into two first order beams, termed the (+) and (−) beams 108, 116. To use the AOTF 100 as a tunable filter, a beam stop 120 or other device is used to block or otherwise eliminate the undiffracted, broadband light 118 and the (+) and/or (−) monochromatic light beams 108, 116 is directed to the experiment. The angle between the beams is a function of device design, but is typically a few degrees. The bandwidth of the selected light depends on the device and the wavelength of operation, and can be as narrow as 1 nm FWHM. Transmission efficiencies are high (up to 98%), with the intensity divided between the (+) and (−) beams.

The systems herein are also applicable to other organs by changing the fiber probe according to specific requirements such as being passed through the biopsy channel of an endoscope. Currently, many EEM measurements are for research purposes only or are conducted in vivo due to the long data acquisition times (in the order of minutes) associated with existing instrumentation. The present devices with fast measurement times (in the order of seconds) make in vivo measurements convenient and efficient, thereby rendering the devices suitable for both research and clinical applications. The rates herein can provide full scans, of about 600 nm of wavelengths (e.g., from about 400 nm to about 1000 nm) at rates as fast as about 1 minute to 10 seconds, to less than about 1 second, or even as fast as video rates such about 30 ms to about 15 ms. Scans of greater width, for example from about 200 nm to about 1100 nm, or shorter width, such as about 200-500 nm (e.g., UV through blue light), 400-600 (most visible wavelengths), or 600-1100 nm (long VIS thorough IR); other wavelength ranges, including discontinuous wavelength ranges, can be scanned as desired. For example the ranges can target a particular type of light or desired light-response, such as UV, VIS, NIR, IR, etc.; fluorescence, Raman, reflectance, etc.

Rapid EEM spectroscopy has additional applications beyond those mentioned above. For example, EEMs can be used to evaluate topical pharmaceuticals, assay and quantify drug delivery in photodynamic therapy, validate the UV light protection of sunscreens, and determine epidermal proliferation. It can even be used to improve the performance of HPLC instrumentation. Hart, et al., A laser-induced fluorescence dual-fiber optic array detector applied to the rapid HPLC separation of polycyclic aromatic hydrocarbons, Anal Bioanal Chem, 372(1): 205-215, 2002.

In other embodiments, the features discussed herein include making or using the systems and devices discussed herein. Such methods can include providing computer-implemented programming for the computer operably connected to one or more of the light sources, AOTFs, detectors, amplifiers and other components of the systems and devices, as well as computer-implemented programming that analyzes, compares, etc., the data obtained from the sample and regarding the components of systems, etc.

The systems also can be modified into an EEM system for UVNIS bands by replacing the VIS/NIR AOTFs with high performance UVNIS AOTFs.

In further aspects, the present discussion includes methods of detecting autofluorescence in a sample. The methods can comprise illuminating the sample with at least one of a long wavelength VIS and NIR excitation light filtered through at least one acousto-optic tunable filter (AOTF), and detecting via a detector fluorescence emission light emanating from the sample. The methods can be computer implemented and can comprise analyzing the emission light and determining therefrom at least one characteristic about melanin in the sample, such as the presence and/or quantity of the melanin.

The methods can further comprise filtering the fluorescence emanation light through a detection AOTF upstream from the detector, amplifying the fluorescence emanation light via an amplifier downstream from the detector, which can be for example a photomultiplier detector, and varying the desired illumination wavelength range of the illumination AOTF to provide a desired fluorescence excitation light and varying the desired detection wavelength range of the detection AOTF to detect fluorescent light from fluorophores excited by the desired fluorescence excitation light. The illumination and emission light can each be through a second AOTF downstream from the respective first AOTF, typically with the various AOTFs operably connected to the computer to work in series. This provides almost complete out of band rejection of undesired light.

The methods can also comprise transmitting the illumination light through an illumination light guide disposed to transmit the illumination light from the illumination AOTF to the sample and transmitting the fluorescence emission light through a detection light guide disposed to transmit the fluorescence emission light from the sample to the detection AOTF. If desired the illumination light guide and the detection light guide can be configured to form a bifurcated light guide wherein the illumination light guide provides an illumination branch and the detection light guide provides a pick-up branch that combine to form a common end. The end of the light guide (whether or not bifurcated) can be configured to non-invasively interrogate skin and the methods can further comprise non-invasively interrogating skin.

The desired illumination wavelength range can be less than about 5 nm, and less than about 1 nm FWHM. The system can selectively excite and selectively detect long wavelength VIS-induced and NIR-induced fluorescence, and the methods can further comprise accessing discrete wavelengths at rates of at least about 10 KHz, as well as varying the illumination light from at least about 400 nm to 1000 nm. The methods still further comprise creating an excitation-emission matrix (EEM) depicting the fluorescence emission light emanating from the sample, which EEM can be a 2-dimensional or 3-dimensional EEM, or otherwise configured as desired.

The systems, methods, etc., herein provide, for example, one or more of the following advantages:

1) Repeatability/Calibration. The transmitted wavelength of an AOTF can be determined by the frequency of the applied RF signal, which can be generated with digital precision. Once it is factory or otherwise initially calibrated, no recalibration may be needed over its lifetime. A typical TeO2 AOTF has a guaranteed wavelength repeatability error of less than ±0.05 nm.

2) Wavelength Purity. In fluorescence measurements, out of band transmission of the filtering device is typically kept to a minimum, at least less than 10-5. The out of band rejection of an AOTF is better than 10-3 with some devices closing to 10-5. In some embodiments, the systems herein use at least two AOTFs in series to provide an out of band rejection of better than 10-6, up to about 10⁻¹⁰. This can be done for each of the excitation and emission module 6s with some sacrifice on the light throughput.

3) Speed/Random Access. When the frequency of the RF signal is changed, the typical rate limiting factor for changing the wavelength is the time it takes for the changed RF to fill the AOTF crystal—typically about 20 microseconds (20 us). This means that entire spectra can be scanned at very high speed, or discrete wavelengths may be accessed at rates of 10 KHz or greater, even when separated by hundreds of nanometers.

4) Computer Control/Integration. The RF driver (generator) can be operably connected to or interfaced with a computer, for example through a RS232 port, so the AOTF can be conveniently programmed by the computer to scan or access different wavelengths rapidly.

5) Efficiency/Sensitivity. The AOTF is a high efficiency device (especially in the NIR wavelength range) with transmission at the selected wavelength as high as 98%. Furthermore, the output of the AOTF is a circular, collimated beam, which is ideally suited for coupling to a light guide such as a fiber or fiber bundle, unlike the exit slit of a monochromator. Other beam geometries such as a square, ellipse, oval, etc. High efficiency translates directly into higher sensitivity and therefore faster data acquisition.

Melanin Long Wavelength VIS- and NIR-Induced Fluorescence

The present invention also includes systems, methods, uses, etc., related to the inventor's discovery that melanin, an important chromophore in human skin, exhibits significant fluorescence emission under long wavelength VIS and NIR light, for example 785 nm NIR light excitation. This is different, for example, from melanin's known ability to very weakly fluorescence at UV or short wavelength VIS. Kozikowski, et al., IEEE J. Quantum Electronics, QE-20(12): 1379-1382, 1984; Gallas, et al., Fluorescence of melanin—dependence upon excitation wavelength and concentration, Photochem Photobiol 45(5): 595-600, 1987.

FIG. 4 depicts fluorescence characteristics from three different melanin samples (Sigma) under 785 nm NIR light excitation. The samples were measured using a Raman spectroscopy system, Huang, et al., A rapid near-infrared Raman spectroscopy system for real-time in vivo skin measurements, Optics Letters 26(22):1782-84, 2001. The samples show definite fluorescence, with a peak about 880 nm-900 nm.

FIG. 5 depicts fluorescence from black and white human hairs under 785 nm NIR light excitation, measured with the Raman system. The black human hair, which is replete with melanin, exhibited much greater fluorescence than the white hair, which contains minimal amounts of melanin. The spectral shape of the black hair curve is very similar to that of melanin samples in FIG. 4. (Spikes on the white hair spectrum are from Raman scattering.) The NIR fluorescence of melanin was confirmed in vivo in hair and skin.

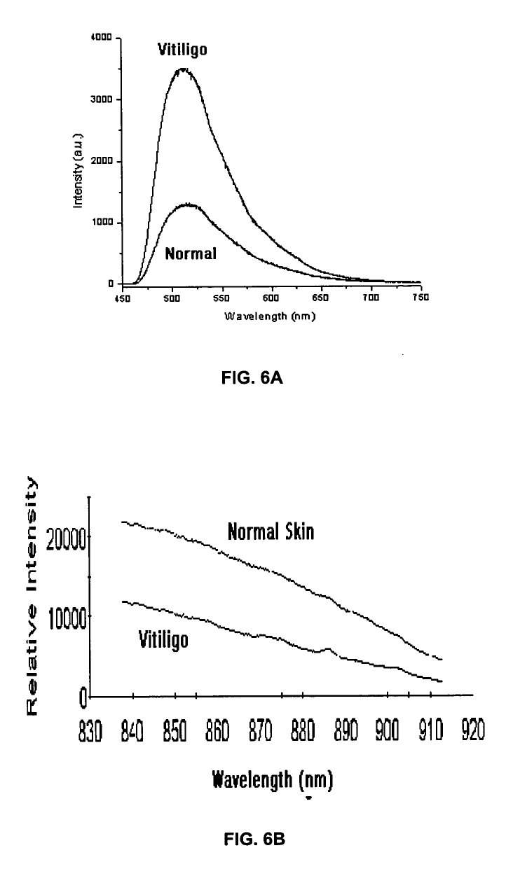

FIG. 6A depicts fluorescence spectra of a vitiligo lesion and its surrounding normal skin measured under 437 nm excitation light. FIG. 6B depicts fluorescence spectra of the same lesion as in FIG. 6A under 785 nm NIR light excitation, measured with the Raman system. Vitiligo is an acquired autoimmune skin disorder characterized specifically by depigmented skin patches lacking melanin. The affected skin patches exhibit increased fluorescence emission relative to the surrounding normal skin under 437 nm excitation (FIG. 6A). This appears to be attributed to the fact that in vitiligo melanin is no longer present to absorb both the excitation and the emitted fluorescence light. However when vitiligo lesions are excited at 785 nm, there is decreased fluorescence as compared to normal skin (FIG. 6B), indicating that melanin in normal skin fluoresces under long VIS and NIR excitation.

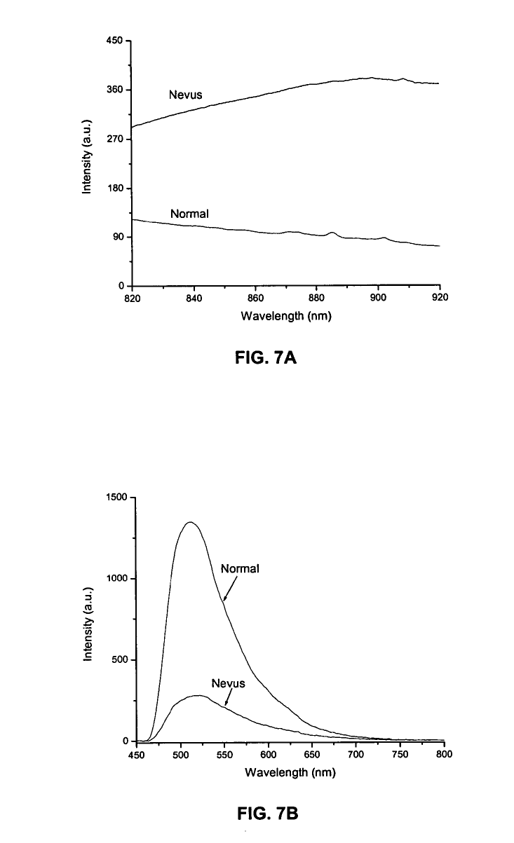

FIG. 7A depicts fluorescence from a compound nevus and its surrounding normal skin under 785 nm NIR light excitation, measured with the Raman system. FIG. 7B depicts a fluorescence spectra of a compound nevus and its surrounding normal skin measured under 437 nm light excitation. These figures show increased autofluorescence in compound nevi (i.e., moles) relative to normal skin under 785 nm excitation, whereas at 437 nm excitation the same lesions exhibit decreased fluorescence. Indeed, for UVNIS excitation autofluorescence of pigmented skin lesions appears to be informative only to the extent that the lower signals are due to the presence of melanin, since any other potentially diagnostic signals are optically masked by melanin, which can create an optical “black hole” in the skin as far as fluorescence is concerned.

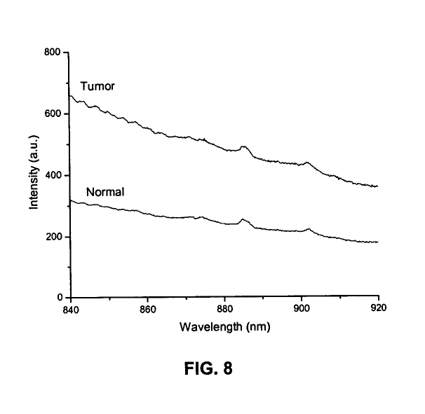

NIR autofluorescence has also been shown in separate experiments unrelated to melanin. FIG. 8 depicts a fluorescence from a mouse subcutaneous tumor and its surrounding normal skin under 785 nm NIR light excitation, measured with the Raman system.

UV and short wavelength VIS excited fluorescence represents only part of the tissue autofluorescence story. It appears that at least melanin contributes to tissue fluorescence in the long wavelength VIS and NIR bands, and that this fluorophore fluctuates dynamically in both health and disease.

From the foregoing, it will be appreciated that, although specific embodiments have been discussed herein for purposes of illustration, various modifications may be made without deviating from the spirit and scope of the disclosure. Accordingly, the systems and methods, etc., include such modifications as well as all permutations and combinations of the subject matter set forth herein and are not limited except as by the appended claims.

What is claimed is:

1. A high speed spectral measurement system comprising at least one light source, an illumination acousto-optic tunable filter (AOTF) configured to receive light from the light source and to selectively transmit substantially only illumination light in a desired illumination wavelength range to a sample, and a detector disposed to detect emission light emanating from the sample, wherein at least the illumination AOTF and the detector are operably connected to a computer that controls the illumination AOTF and the detector and integrates data regarding the illumination AOTF and the detector.

2. The spectroscopy system of claim 1 wherein the system further comprises a detection AOTF configured to receive emission light from the sample and to selectively transmit to the detector substantially only light in a desired detection wavelength range.

3. The spectroscopy system of claim 2 wherein the desired detection wavelength range comprises emission light from fluorophores excited by the fluorescence excitation light.

4. The spectroscopy system of claim 2 wherein the detector is a photomultiplier detector.

5. The spectroscopy system of claim 2 wherein the computer is configured to vary the desired illumination wavelength range of the illumination AOTF to provide a desired fluorescence excitation light and is configured to vary the desired detection wavelength range of the detection AOTF to detect fluorescent light from fluorophores excited by the desired fluorescence excitation light.

6. The spectroscopy system of claim 1 wherein the system further comprises a second illumination AOTF downstream from the first illumination AOTF and operably connected to the computer to work in series with the first illumination AOTF to provide almost complete out of band rejection of undesired light.

7. The spectroscopy system of claim 6 wherein the out of band rejection is better than at least about 10-6.

8. The spectroscopy system of claim 2 wherein the system further comprises a second detection AOTF downstream from the first detection AOTF and operably connected to the computer to work in series with the first detection AOTF to provide almost complete out of band rejection of undesired light.

9. The spectroscopy system of claim 8 wherein the system further comprises a second detection AOTF downstream from the first detection AOTF and operably connected to the computer to work in series with the first detection AOTF to provide almost complete out of band rejection of undesired light.

10. The spectroscopy system of claim 9 wherein the out of band rejection is better than at least about 10-6.

11. The spectroscopy system of claim 2 or 4 wherein the system further comprises an illumination light guide disposed to transmit the illumination light from the illumination AOTF to the sample and a detection light guide disposed to transmit the detection light from the sample to the detection AOTF.

12. The spectroscopy system of claim 11 wherein the illumination light guide and the detection light guide are flexible light guide bundles each comprising a plurality of optical fibers.

13. The spectroscopy system of claim 11 wherein the illumination light guide and the detection light guide are configured to form a bifurcated light guide wherein the illumination light guide provides an illumination branch and the detection light guide provides a pick-up branch that combine to form a common end.

14. The spectroscopy system of claim 12 wherein the illumination light guide and the detection light guide are configured to form a bifurcated light guide wherein the illumination light guide provides an illumination branch and the detection light guide provides a pick-up branch of the bifurcated light guide that combine to form a common end.

15. The spectroscopy system of claim 14 wherein the bifurcated light guide is configured to non-invasively interrogate skin.

16. The spectroscopy system of claim 1 or 2 wherein the system is configured such that the desired illumination wavelength range is less than about 5 nm.

17. The spectroscopy system of claim 1 or 2 wherein the system is configured such that the desired illumination wavelength range is less than about 1 nm FWHM.

18. The spectroscopy system of claim 1 or 2 wherein the system is configured such that the system can selectively excite and selectively detect long wavelength VIS-induced and NIR-induced fluorescence.

19. The spectroscopy system of claim 1 or 2 wherein the system is configured to access discrete wavelengths at rates of at least about 10 KHz.

20. The spectroscopy system of claim 1 or 2 wherein the system is configured to vary the illumination light from at least about 400 nm to 1000 nm.

21. A high speed excitation-emission matrix (EEM) spectroscopy system comprising at least one light source, an illumination acousto-optic tunable filter (AOTF) configured to receive light from the light source and to selectively transmit substantially only fluorescence excitation light in a desired illumination wavelength range to a sample, a detection AOTF configured to receive emission light from the sample and to selectively transmit to a detector substantially only light in a desired detection wavelength range that comprises emission light from fluorophores excited by the fluorescence excitation light, wherein at least the illumination AOTF, the detection AOTF and the detector are operably connected to a computer that controls the illumination AOTF, the detection AOTF and the detector and integrates data regarding the illumination AOTF, the detection AOTF and the detector to provide an EEM of the sample.

22. The spectroscopy system of claim 21 wherein the EEM is a 2-dimensional EEM.

23. The spectroscopy system of claim 21 wherein the EEM is a 3-dimensional EEM.

24. The spectroscopy system of claim 21 wherein the detector is a photomultiplier detector.

25. The spectroscopy system of claim 21 wherein the system is configured to operate at rates sufficient to obtain substantially complete data for an EEM from about 400 nm to 1000 nm at excitation wavelength steps separated by about 10 nm in less than about 3 seconds.

26. The spectroscopy system of claim 21 wherein the system is configured to operate at rates sufficient to obtain substantially complete data for an EEM from about 400 nm to 1000 nm at excitation wavelength steps separated by about 10 nm in less than about 0.9 seconds.

27. The spectroscopy system of claim 21 wherein the system is configured to operate at rates sufficient to obtain substantially complete data for an EEM from about 400 nm to 1000 nm at excitation wavelength steps separated by about 10 nm in less than about 30 ms.

28. The spectroscopy system of claim 21 wherein the system is configured to operate at rates sufficient to obtain substantially complete data for an EEM from about 400 nm to 1000 nm at excitation wavelength steps separated by about 10 nm in less than about 15 ms.

29. The spectroscopy system of claim 21 wherein the system further comprises a second illumination AOTF downstream from the first illumination AOTF and operably connected to the computer to work in series with the first illumination AOTF to provide almost complete out of band rejection of undesired light, and a second detection AOTF downstream from the first detection AOTF and operably connected to the computer to work in series with the first detection AOTF to provide almost complete out of band rejection of undesired light.

30. The spectroscopy system of claim 29 wherein the out of band rejection is better than at least about 10-6.

31. The spectroscopy system of claim 21 wherein the system further comprises an illumination light guide disposed to transmit the illumination light from the illumination AOTF to the sample and a detection light guide disposed to transmit the detection light from the sample to the detection AOTF.

32. The spectroscopy system of claim 29 wherein the system further comprises an illumination light guide disposed to transmit the illumination light from the illumination AOTF to the sample and a detection light guide disposed to transmit the detection light from the sample to the detection AOTF.

33. The spectroscopy system of claim 31 or 32 wherein the illumination light guide and the detection light guide are flexible light guide bundles each comprising a plurality of optical fibers.

34. The spectroscopy system of claim 31 wherein the illumination light guide and the detection light guide are configured to form a bifurcated light guide wherein the illumination light guide provides an illumination branch and the detection light guide provides a pick-up branch that combine to form a common end.

35. The spectroscopy system of claim 32 wherein the illumination light guide and the detection light guide are configured to form a bifurcated light guide wherein the illumination light guide provides an illumination branch and the detection light guide provides a pick-up branch that combine to form a common end.

36. The spectroscopy system of claim 33 wherein the illumination light guide and the detection light guide are configured to form a bifurcated light guide wherein the illumination light guide provides an illumination branch and the detection light guide provides a pick-up branch of the bifurcated light guide that combine to form a common end.

37. The spectroscopy system of claim 36 wherein the bifurcated light guide is configured to non-invasively interrogate skin.

38. The spectroscopy system of claim 21 wherein the system is configured such that the desired illumination wavelength range is less than about 5 nm.

39. The spectroscopy system of claim 21 wherein the system is configured such that the desired illumination wavelength range is less than about 1 nm FWHM.

40. The spectroscopy system of claim 21 wherein the system is configured such that the system can selectively excite and selectively detect long wavelength VIS-induced fluorescence and NIR-induced fluorescence.

41. The spectroscopy system of claim 21 wherein the system is configured to access discrete wavelengths at rates of at least about 10 KHz.

42. The spectroscopy system of claim 21 wherein the system is configured to vary the illumination light from at least about 400 nm to 1000 nm.

43. A method of detecting autofluorescence in a sample comprising:
Illuminating the sample with at least one of a long wavelength VIS and NIR excitation light filtered through at least one acousto-optic tunable filter (AOTF), and
detecting via a detector fluorescence emission light emanating from the sample.

44. The method of claim 43 wherein the method is computer implemented.

45. The method of claim 44 wherein the method further comprises analyzing the emission light and determining therefrom at least one characteristic about melanin in the sample.

46. The method of claim 44 wherein the method further comprises filtering the fluorescence emanation light through a detection AOTF upstream from the detector.

47. The method of claim 44 wherein the method further comprises amplifying the fluorescence emanation light via an amplifier downstream from the detector.

48. The method of claim 44 wherein the detector is a photomultiplier detector.

49. The method of claim 44 wherein the computer varies the desired illumination wavelength range of the illumination AOTF to provide a desired fluorescence excitation light and varies the desired detection wavelength range of the detection AOTF to detect fluorescent light from fluorophores excited by the desired fluorescence excitation light.

50. The method of claim 49 wherein the method further comprises filtering the emission light through a second detection AOTF downstream from the first detection AOTF and operably connected to the computer to work in series with the first detection AOTF, to provide almost complete out of band rejection of undesired light.

51. The method of claim 44 or 50 wherein the method further comprises filtering the illumination light through a second illumination AOTF downstream from the first illumination AOTF and operably connected to the computer to work in series with the first illumination AOTF, to provide almost complete out of band rejection of undesired light.

52. The method of claim 44 wherein the method further comprises transmitting the illumination light through an illumination light guide disposed to transmit the illumination light from the illumination AOTF to the sample and transmitting the fluorescence emission light through a detection light guide disposed to transmit the fluorescence emission light from the sample to the detection AOTF, wherein the illumination light guide and the detection light guide are configured to form a bifurcated light guide wherein the illumination light guide provides an illumination branch and the detection light guide provides a pick-up branch that combine to form a common end.

53. The method of claim 52 wherein the bifurcated light guide is configured to non-invasively interrogate skin and the method further comprises non-invasively interrogating skin.

54. The method of claim 44 wherein the method is configured such that the desired illumination wavelength range is less than about 5 nm.

55. The method of claim 44 wherein the method is configured such that the desired illumination wavelength range is less than about 1 nm FWHM.

56. The method of claim 44 wherein the method is configured such that the system can selectively excite and selectively detect long wavelength VIS-induced and NIR-induced fluorescence.

57. The method of claim 44 wherein the method further comprises accessing discrete wavelengths at rates of at least about 10 KHz.

58. The method of claim 44 wherein the method further comprises varying the illumination light from at least about 400 nm to 1000 nm.

59. The method of claim 44 wherein the method further comprises creating an excitation-emission matrix (EEM) depicting the fluorescence emission light emanating from the sample.

60. The method of claim 44 wherein the EEM is a 2-dimensional EEM.

61. The method of claim 44 wherein the EEM is a 3-dimensional EEM.

62. A method of analyzing melanin in a sample comprising:
a) illuminating the sample with excitation light comprising at least one of long wavelength visible (VIS) and near infrared (NIR) light;
b) inducing autofluorescence from the melanin due to the excitation light; and,
c) measuring the autofluorescence and therefrom analyzing at least one characteristic of the melanin.

63. The method of claim 62 wherein the excitation light consists essentially of long wavelength visible (VIS) and near infrared (NIR) light.

64. The method of claim 62 or 63 wherein the long wavelength visible (VIS) and near infrared (NIR) light consists essentially of 785 nm light.

65. The method of claim 62 or 63 wherein the autofluorescence is induced and measured in less than about 30 ms.

66. The method of claim 62 or 63 wherein the autofluorescence comprises a peak at about 880 nm-900 nm and the analyzing comprises using the peak to identify the melanin.

67. The method of claim 62 or 63 wherein the method further comprises quantifying the amount of melanin in the sample.

68. The method of claim 62 wherein the autofluorescence is induced and measured using a system according to any one of claims 2, 6, 8, 9, 13 and 15.

69. The method of claim 62 wherein the autofluorescence is induced and measured using a system according to any one of claims 21, 24, 28, 31, 32, 37.

70. A method of rapidly detecting autofluorescence in a sample comprising:
scanning the sample with an about 5 nm wavelength band of excitation light, the scanning covering a wavelength range of at least about 200 nm of wavelengths of light and proceeding at a rate fast enough to covering at least about 600 nm of wavelengths in less than about 10 seconds, and
detecting through a filter configured to substantially block the excitation light fluorescence emission light emanating from the sample.

71 The method of claim 70 wherein the scanning covers at least about 600 nm of wavelengths and proceeds at a rate fast enough to scan the about 600 nm of wavelengths in less than about 1 seconds.

72. The method of claim 70 or 71 wherein the scanning proceeds at a rate fast enough to scan the about 600 nm of wavelengths in less than about 30 ms.

73. The method of claim 70 or 71 wherein the scanning proceeds at a rate fast enough to scan the about 600 nm of wavelengths in less than about 15 ms.

74. The method of claim 70 or 71 wherein the scanning covers a wavelength range consisting essentially from about 200 nm to about 1100 nm.

75. The method of claim 70 or 71 wherein the scanning covers a wavelength range comprising UV wavelengths.

76. The method of claim 70 or 71 wherein the scanning covers a wavelength range comprising long wavelength visible (VIS) and near infrared (NIR) light.

77. The method of claim 70 or 71 wherein the wavelength band of excitation light has a width less than about 1 nm FWHM.

78. The method of claim 70 wherein the method is computer implemented.

79. The method of claim 78 wherein the method further comprises passing the excitation light through at least one acousto-optic tunable filter (AOTF) upstream from the sample and the detecting comprises filtering the fluorescence emanation light through a detection AOTF upstream from the detector.

80. The method of claim 70 or 78 wherein the method further comprises amplifying the fluorescence emanation light via an amplifier downstream from the detector.

81. The method of claim 70 or 78 wherein the method further comprises filtering the emission light through a second detection AOTF downstream from the first detection AOTF and operably connected to the computer to work in series with the first detection AOTF, to provide almost complete out of band rejection of undesired light.

82. The method of claim 70 or 78 wherein the method further comprises transmitting the illumination light through an illumination light guide disposed to transmit the illumination light from the illumination AOTF to the sample and transmitting the fluorescence emission light through a detection light guide disposed to transmit the fluorescence emission light from the sample to the detection AOTF, wherein the illumination light guide and the detection light guide are configured to form a bifurcated light guide wherein the illumination light guide provides an illumination branch and the detection light guide provides a pick-up branch that combine to form a common end.

83. The method of claim 82 wherein the bifurcated light guide is configured to non-invasively interrogate skin and the method further comprises non-invasively interrogating skin.

84. The method of claim 70 or 78 wherein the method further comprises accessing discrete wavelengths at rates of at least about 10 KHz.

85. The method of claim 70 or 78 wherein the method further comprises creating an excitation-emission matrix (EEM) depicting the fluorescence emission light emanating from the sample.

86. A method of analyzing a sample for presence of cancer comprising:
a) illuminating the sample with excitation light comprising at least one of long wavelength visible (VIS) and near infrared (NIR) light;
b) inducing autofluorescence from cancerous portions in the sample, if any, due to the excitation light; and,
c) measuring the autofluorescence and therefrom analyzing at least one characteristic of the possible cancer.

87. The method of claim 86 wherein the excitation light consists essentially of long wavelength visible (VIS) and near infrared (NIR) light.

88. The method of claim 86 or 87 wherein the long wavelength visible (VIS) and near infrared (NIR) light consists essentially of about 785 nm light.

89. The method of claim 86 or 87 wherein the autofluorescence is induced and measured in less than about 30 ms.

90. The method of claim 86 wherein the autofluorescence is induced and measured using a system according to any one of claims 2, 6, 8, 9, 13 and 15.

91. The method of claim 86 wherein the autofluorescence is induced and measured using a system according to any one of claims 21, 24, 28, 31, 32, 37.
